(19) United States
(12) Patent Application Publication
(10) Pub. No.: US 2011/0063960 A1
(43) Pub. Date: Mar. 17, 2011

(54) OPTICAL DISC APPARATUS

(76) Inventor: Tatsuya ISHITOBI, Kawasaki (JP)

(21) Appl. No.: 12/853,515

(22) Filed: Aug. 10, 2010

(30) Foreign Application Priority Data
Sep. 14, 2009 (JP) 2009-211243

(51) Int. Cl. G11B 20/10

(52) U.S. Cl. 369/47.15; G9B/20.009

(57) ABSTRACT

An optical disc apparatus, being improved in a random access speed thereof and superior in a usability thereof, comprises: a virtual disc for memorizing data of at least one (1) pieces of an optical disc; a recording/reproducing means for executing reproduction of data from the optical disc and recording of data onto the optical disc; and a system controller means for controlling the virtual disc and the recording/reproducing means.

This application relates to and claims priority from Japanese Patent Application No. 2009-211243 filed on Sep. 14, 2009, the entire disclosure of which is incorporated herein by reference.

### BACKGROUND OF THE INVENTION

The present invention is a technology relating to an optical disc apparatus.

As an example of a method for conducting data transfer between an optical disc apparatus and a host apparatus thereof, the following is described in a column of the conventional art of the Patent Document 1 mentioned below:

“A hard disk emulator is a high grade memory system having an optical disc apparatus, and a hard disk apparatus having relatively high speed and a capacity equal or less than that of the optical disc or a non-volatile memory as a data cache. From a host computer, it can be seen as a hard disc having the capacity of the optical disc or an optical disc apparatus; however with storing a part or all of data stored on the optical disc within the high speed data cache, temporarily, a high speed data transfer is achieved between the host.”

### PRIOR ART DOCUMENTS

### Patent Documents

[Patent Document 1] Japanese Patent Laying-Open No. Hei 7-175602 (1995).

### BRIEF SUMMARY OF THE INVENTION

With the optical disc, since it accompanies mechanical operations, such as, movement of an optical pickup, etc., for example, when recording or reproducing onto/from an optical disc, and in particular, in the recording and reproducing operations accompanying a random access therewith, there is a drawback that the data transfer speed is lowered down to the optical disc.

Also, in case where the optical disc is not loaded into the optical disc apparatus, there is a drawback that a request for reading out data from the optical disc cannot be received, or a request for writing data onto the disc, from the host apparatus of the optical disc apparatus.

The present invention, accomplished for dissolving the drawback mentioned above, and an object of the present invention is to provide an optical disc improved in a random access speed; thereby being superior in the usability thereof.

The object mentioned above can be achieved by the invention described in the pending claims, as an example.

According to the present invention, it is possible to improve the random access speed thereof, and thereby to provide an optical disc apparatus being superior in the usability thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 shows an example of an optical disc apparatus, according to the present invention;

FIG. 2 shows an example of using a region of a virtual disc; and

FIG. 3 shows other example of an optical disc apparatus, according to the present invention.

### DETAILED DESCRIPTION OF THE PREFERRED EMBODIMENTS

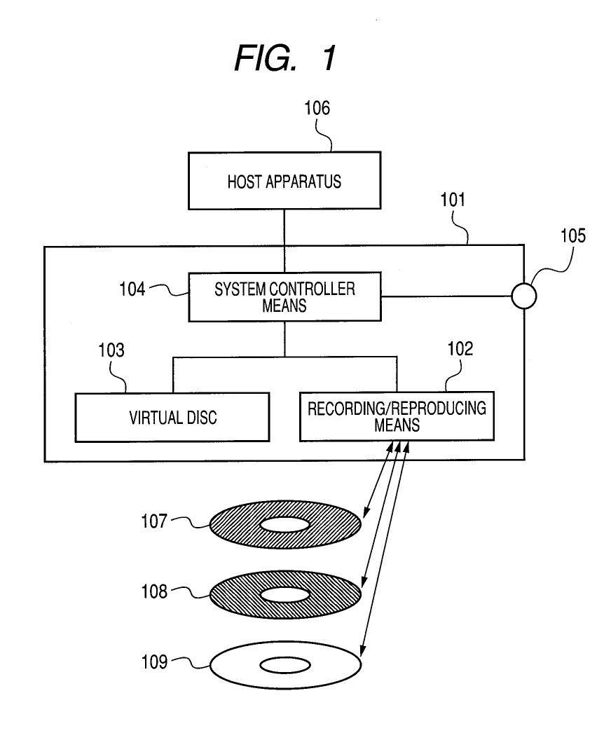

FIG. 1 shows an example of an optical disc for implementing the present invention.

A reference numeral 101 in FIG. 1 depicts an optical disc apparatus, and it is constructed with a recording/reproducing means shown by 102 in the same figure, a virtual disc shown by 103 in the same figure, and a system controller means shown by 104 in the same figure.

The recording/reproducing means 102 carries out a roll of writing data onto the optical disc and reading out data from the optical disc.

The virtual disc shown by 103 is built up with a semiconductor memory, and has a capacity of enabling to store the data of at least one (1) piece of the optical disc thereon. In case where the optical disc apparatus is able to deal with (or compatible with) plural kinds of optical discs, differing in the standard or regulation thereof, the semiconductor memory can be so constructed with that it has the capacity more than the one (1) piece of the optical disc, being large in the capacity thereof. For example, the optical disc apparatus 101 is able to record or reproduce CD, DVD and BD, it is possible to determine or set up the capacity of the semiconductor memory to store the data more than at least one (1) piece of BD. Although no matter if it may be a volatile or non-volatile one, because a large effect can be obtained if determining to be the non-volatile one, it is assumed that the semiconductor memory for building up the virtual disc 103 is a non-volatile memory in the explanation, which will be given below.

The system controller means 104 carries out the roll of managing or controlling the operations of the optical disc apparatus as a whole.

A reference numeral 105 in the same figure depicts a disc discharge button for accepting an optical disc discharge request from an outside of the optical disc apparatus 101.

A reference numeral 106 in the same figure depicts a host apparatus of the optical disc apparatus 101. The optical disc apparatus 101 can access to the data, which is recorded on the optical disc, through the optical disc apparatus 101.

Hereinafter, explanation will be given why a random access speed can be increased within the optical disc apparatus shown in FIG. 1.

Hereinafter, explanation will be made with pointing out a case where the optical disc 107 shown in FIG. 1 is inserted therein. However, it is assumed that the optical disc 107 is under such a condition that the data is already recorded thereon and it is reproducible therefrom.

When the optical disc 107 is inserted into the optical disc apparatus 101, the system controller means 104 secures or maintain a region having the same capacity to that of the optical disc 107 within the virtual disc 103 (the region maintained within the virtual disc 103 will be called, a “virtual disc region”, hereinafter), after reading out the information, such as, a sort or a recording capacity of the disc, for example, from the optical disc 107 through the recording/reproducing means 102. And, the system controller means 104 reads out the data recorded on the optical disc 107 through the recording/reproducing means 102, and it transfers the data read out into the region, which is maintained within the virtual disc 103. Also, the system controller means 104 records the data into the virtual disc 103, together with management information for managing or controlling the data of the optical disc 107, which is stored in the virtual disc 103.

With the operations mentioned above, all of the data recorded on the optical disc 107 are stored within the virtual disc 103, to be managed or controlled thereafter. However, when transferring the data from the optical disc to the virtual disc region, the data is reproduced, sequentially, from the optical disc, by means of sequential access.

After doing as was mentioned above, when data reproduction of the optical disc 107 is requested from the host apparatus 106, the data read out from the virtual disc 103 is transferred to the host apparatus 106, without reading out the data from the optical disc 107.

For example, when a request is made from the host apparatus 106, for reproducing the data for 100 blocks, starting from a head, an address No. 100 on the optical disc 107, the data for 100 blocks from the addresses on the virtual disc region within the virtual disc 103 corresponding to the address No. 100 on the optical disc 107, and is transferred to the host apparatus 106.

As was explained, previously, since the virtual disc 103 is constructed with the semiconductor memory, no mechanical operation is accompanied with, such as, moving operation of the optical pickup, etc., for example, when reading out the data. Accordingly, with doing as was mentioned above, comparing to the conventional optical disc apparatus, it is possible to obtain an effect of supplying the data to the host apparatus at a high speed and with silence. Also, since it is superior also in random accessibility, there can be obtained an effect for enabling to deal with, even a data transfer request, which needs random accessing from the host apparatus, without falling down the speed (this effect is called a first effect, hereinafter).

Next, other effect of the optical disc apparatus according to the present invention will be explained with picking up the case where the optical disc 107, which was explained in the above, is discharged from the optical disc.

When the discharge button 105 is pushed down shown in FIG. 1, the request for discharging the disc is transferred to the system controller means 104. The system controller means 104, upon receipt of the disc discharge request, instructs the recording/reproducing means 102 to discharge the disc therefrom. With this, although the optical disc 107 is discharged from the optical disc apparatus 101, however at this time, the system controller means 104 operates to hold the data of the disc 107, which is stored within the virtual disc 103, continuously. With this, since it can be said that, all of the data of the optical disc 107 exist within the optical disc apparatus, continuously, there can be obtained an effect for enabling to transfer the data of the optical disc to the host apparatus 106, continuously (this effect is called a second effect, hereinafter), even under the condition that there is no disc within the optical disc apparatus.

Further, explanation will be given on other effect of the optical disc apparatus, according to the present invention, with picking up the case where an optical disc 108 shown in FIG. 1 is inserted into the optical disc apparatus 101, after discharging the optical disc 107 therefrom. However, it is assumed that the optical disc 108 is under such a condition that the data is already recorded thereon and it is reproducible therefrom.

When the optical disc 108 is inserted into the optical disc apparatus 101, the system controller means 104 reads out the information, such as, a sort or a recording capacity of the disc, for example, from the optical disc 108 through the recording/reproducing means 102. And, separating from the virtual disc region on the optical disc 107, which was already kept, a virtual disc region corresponding to the optical disc 108 is kept within the virtual disc 103. And, the system controller means 104 reads out the data, which is recorded on the optical disc 108 through the recording/reproducing means 102, and transfers the data read out to the virtual disc region, which is maintained within the virtual disc 103. Also, the system controller means 104 records the data into the virtual disc 103, together with management information for managing or controlling the data of the optical disc 108, which is stored in the virtual disc 103.

With the operations mentioned above, all of the data recorded on the optical discs 107 and 108 are stored within the virtual disc 103, to be managed or controlled thereafter. With this, the optical disc apparatus 101 is in such a condition that it can transfer the data of both to the host apparatus 106. If doing so, as far as the capacity of the virtual disc 103 is permissible, it is possible to keep the virtual disc regions corresponding to the plural numbers of optical discs. Further, since also the management information for each optical disc is recorded on the virtual disc 103, it is possible to determine on whether the virtual disc region is kept or not for the optical disc, which is inserted into the optical disc apparatus 101. Accordingly, even if the same optical disc is inserted and discharged, repetitively, only one (1) virtual disc region is kept corresponding to that optical disc.

In this manner, in case where the virtual disc regions exist within the virtual disc 103, corresponding to the plural numbers of optical discs, it is also possible to read out the data only from the virtual disc region corresponding to the optical disc, which is inserted into the optical disc apparatus more recently.

If the optical discs are inserted into the optical disc apparatus 101, in such an order, i.e., the optical disc 107, the optical disc 108 and the optical disc 107, for example, since the optical disc 107 is the optical disc, which is inserted more recently, then the data is read out only from the virtual disc region corresponding to the optical disc 107. Also, after this, if the optical disc is discharged from, then during the time-period until when the optical disc is inserted newly, the data is readout only from the virtual disc region of the optical disc 107. Further, thereafter, if the optical disc 108 is inserted, the data is read out only from the virtual disc region of the optical disc 108.

Further, regarding an optical disc, with which reading-out of the data from the virtual disc region becomes a matter under the condition where no optical disc is within the optical disc apparatus, from a viewpoint of the copyright protection, for example, it is preferable to read the data from the corresponding virtual disc region, as far as the optical disc lies within the optical disc apparatus. Also, in case where the data recorded on the optical disc is encrypted, it is preferable to bring the data to be stored in the virtual disc region into the same condition thereto, i.e., being encrypted, too.

As was mentioned above, if maintaining the virtual disc regions corresponding to the plural numbers of optical discs within the virtual disc 103, with any one of the optical discs, the virtual disc regions of which are kept therein, it is possible to read out the data, immediately, from the virtual disc region corresponding thereto. Thus, regarding the plural numbers of optical discs, there can be obtained the first and second effects mentioned above.

In the above mentioned is shown the effects when reproducing the data from the optical disc (s); however, the present invention is also useful when recording data on the optical disc(s).

Hereinafter, explanation will be made on an effect when recoding data on the optical disc, with picking up an example of recording data on an optical disc 109, which was shown in FIG. 1. However, herein, it is assumed that the optical disc 109 is an optical disc under a non-recorded condition, i.e., no data is recorded thereon.

When the optical disc 109 is inserted into the optical disc apparatus 101, the system controller means 104, after reading out the information, such as, the sort of a disc, the recording capacity thereof, etc., for example, from the optical disc 109, through the recording means 102, keeps a virtual disc region, having the same capacity to that of the optical disc 109, within the virtual disc 103, and also records the management information about the optical disc 109 into the virtual disc 103.

With doing this, all of the data to be recorded on the optical disc 109, which are transferred from the host apparatus 106, are stored within the virtual disc region corresponding to the optical disc 109. For example, in case where the host apparatus 106 makes a request for recording the data for 100 blocks, starting from a head, the address No. 100 on the optical disc 109, the data is written into a region for 100 blocks from an address on the virtual disc region corresponding to the address No. 100 of the optical disc 109.

Recording of data on the substance of the optical disc 109 is executed when the data to be recorded on the optical disc 109 is determined. For example, firstly when a request for discharging the optical disc 109 is made from the host apparatus 106, the data, which is written into the virtual disc region, is recorded on the optical disc 109. When recording the data on the optical disc 109, irrespective of the order of writing of the data into the virtual disc region, mainly is executed a sequential access recording. Thus, even if it is a random access recording when recording the data into the virtual disc region, the data is read out from the virtual disc region, one by one, through a sequential access, when recording it on the optical disc 109, and then it is recorded on the optical disc in this order through the sequential access. And, after completing the recording of all the data, the optical disc 109 is discharged from.

As was explained previously, since the virtual disc 103 is built up with the semiconductor memory, it accompanies no mechanical operation, such as, movement of the optical pickup, etc., for example, when it records the data therein. Accordingly, it is possible to respond the recording of data needing the random access to the request from the host apparatus, without falling down the speed thereof. Also, when recording the data on the optical disc, since the sequential access recording is executed, mainly, there can be obtained an effect that this can be executed with a relatively high speed.

Also, since the virtual disc 103 is rewritable, therefore even if the optical disc is a disc, on which the data can be written only once, the virtual disc region corresponding to that optical disc can be rewritten by any number of times. Accordingly, during the time when the host apparatus determines the data to be written on the optical disc, there can be obtained an effect that the data can be written into the region of the same address by any number of times.

Also, the virtual disc region is maintained when discharging the optical disc, and thereafter, when an optical disc, which is the same sort and unrecorded, is inserted into the optical disc apparatus, then correspondence may be made between it and the virtual disc region maintained, without maintaining the virtual disc region newly. And, without reception of an instruction from the host apparatus, the data on the virtual disc region may be recorded on the optical disc. With doing this, there can be obtained an effect that copying of the optical discs having the same contents can be made by a single body of the optical disc apparatus. When doing such an operation, the optical disc apparatus may discharge the optical disc, automatically, when completing the recording of data on the optical disc, without receiving an instruction from the host apparatus. Also, with doing this, since the data can be recorded on the optical disc without transfer of the data from the host apparatus, there can be obtained an effect that the recording of data can be made on the optical disc by a single body of the optical disc apparatus, even under the condition where the data transfer cannot be made from the host apparatus.

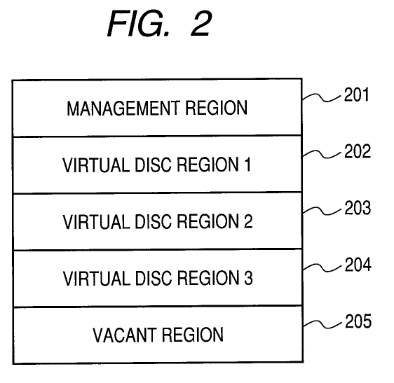

In the above, although the explanation was med on the effects of the present invention, with picking up the case where the optical disc 107, the optical disc 108 and the optical disc 110 are inserted into the optical disc apparatus, heretofore, however an example will be shown in FIG. 2, utilizing the region of the virtual disc 103, for the purpose of obtaining those effects.

A reference numeral 201 in FIG. 2 depicts a management information region for recording therein the management information for managing or controlling the data of the optical disc, which is recorded into the virtual disc 103. Reference numerals 202, 203 and 204 in the same figure depict the virtual disc regions, corresponding to the optical disc 107, the optical disc 108 and the optical disc 109, respectively. A reference numeral 203 depicts a vacant or empty region, to which the virtual disc region is not yet assigned; however, when storing data on the optical disc newly, a virtual disc region is maintained within this vacant region 203. As is shown in FIG. 2, it is possible to maintain plural numbers of virtual disc regions within the virtual disc, but a size or volume of each virtual disc region may be determined depending on the optical disc; there is no necessity of brining all of them into a same size or volume. Also, since the capacity of the virtual disc is not infinite, there is a limitation in a number of the virtual disc regions that can be maintained. If there is generated a necessity of maintaining a new virtual disc region, assumingly, under the condition that no vacancy is in the virtual disc, then it is possible to maintain that new virtual disc region therein, while cancelling the oldest virtual disc region therefrom. Also, if the virtual disc is built up with the non-volatile semiconductor memory, for example, since the data stored in that virtual disc can be maintained even under the condition of no power is supplied thereto, then there can be obtained an effect that the usability thereof can be increased.

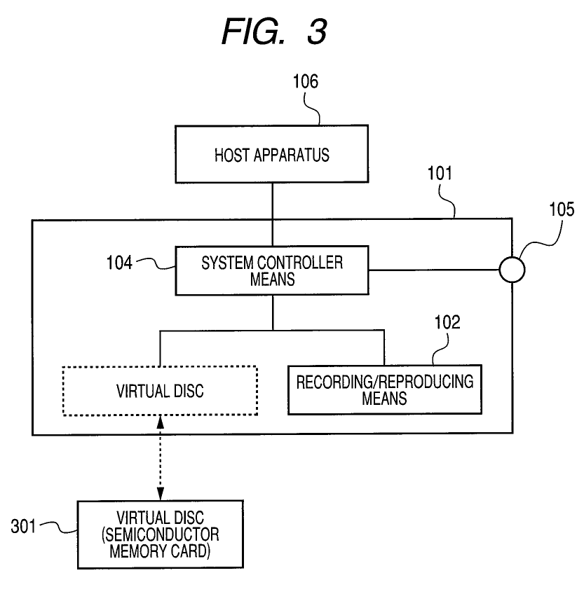

Further, the virtual disc 103 of the optical disc apparatus 101 shown in FIG. 1 may be made in the form of a semiconductor memory card to be removable or detachable, as is shown in FIG. 3. In this FIG. 3, a reference numeral 301 depicts the virtual disc. This virtual disc 301 can be removed from the optical disc apparatus 101, and it is the non-volatile semiconductor memory. With adopting the optical disc apparatus in such structure, since plural numbers of virtual discs can be replace with, therefore it is possible to escape from a problem of shortage of the vacant capacity of the virtual disc. Also, when the semiconductor card as the virtual disc is not inserted into the optical disc apparatus 101, the data read out from the optical disc is transferred, not through the virtual disc, but directly to the host apparatus, or the data transferred to the host apparatus may be recorded directly on the optical disc; i.e., in the similar manner to that of the conventional optical disc apparatus. Or, the removable semiconductor memory may be constructed, in such that it can be used when it is installed into other optical disc apparatus, or may make a protection so that the use thereof is inhibited or limited within other optical disc apparatus.

However, herein is shown the example of building up the virtual disc 103 in the form of the removable semiconductor memory cart; however, the removable semiconductor memory may be made so that it can be added to the virtual disc 103 already existing there. Thus, it can be so constructed that the shortage of the vacant capacity of the virtual disc is filled up with the removable semiconductor memory card.

As was explained in the above, the optical disc apparatus according to the present invention is able to receive a request for reading out the data from the optical disc or a request for writing the data on the optical disc, which is made from the host apparatus of the optical disc apparatus, even in the case where no optical disc is inserted into the optical disc apparatus.

With the optical disc apparatus according to the present embodiment, since it executes rewriting of data on the virtual disc, even when rewriting of data occurs frequency, therefore it is possible to dispose the data, optimally, when recording it on the optical disc 109. Therefore, it is possible to record the data more effectively comparing to the case when recording the data directly on the optical disc 109. Processing for optimally aligning the data to be recorded on the optical disc 109 can be executed, for example, when there is no request of recording or reproduction from a host apparatus; however, it should not be limited to this.

Also, when the optical disc 109 is installed into the optical disc apparatus, thereby to record the data, which is recorded on the optical disc 109 onto the virtual disc 103, the data may be recorded on the virtual disc, after being coded. When the data recorded on the optical disc 109 can be copied, freely, without the copyright thereof, the data may be remained on the virtual disc 103 even after the optical disc 109 is discharged from the optical disc apparatus.

Also, the data may be deleted in connection with discharge of the optical disc 109 from the optical disc apparatus, or may be controlled as if being deleted, from the host apparatus, but not deleted, actually.

Also, when the virtual disc 103 is conducted with a detachable semiconductor memory card for wide purposes, the data may be coded or protected so that it cannot be read out from the semiconductor memory card with using other reproducing apparatuses.

Further, the present invention should not be limited to the embodiments mentioned above, but it may include various kinds of variations thereof. For example, the embodiments mentioned above are explained in the details thereof, for the purpose of explaining the present invention to be understood easily, and it should not always be restricted to that including all the constituent elements explained in the above. Also, it is possible to replace a part of the constituent elements of a certain embodiment with the constituent element(s) of other embodiment, and also to add the constituent element(s) of other embodiment to those of a certain embodiment. Or, regarding a part of the structures of each embodiment, it is also possible to add, delete, or replace other constituent element(s).

Also, with each of the structures mentioned above, a part or all of those may be constructed with hardware, or may be so constructed that it can be achieved by executing by a program with an aid of a processor. Also, control lines and information lines are shown, which can be considered necessary for the explanation; however, it is not always true that all of the control lines and the information lines necessary for the product are shown. Actually, it can be considered that almost of all the constituent elements are connected with one another.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An optical disc apparatus, for enabling recording/reproducing onto/from an optical disc, comprising:
a virtual disc, which is configured to memorize data of at least one (1) pieces of an optical disc;
a recording/reproducing portion, which is configured to execute reproduction of data from said optical disc and recording of data onto said optical disc; and
a system controller portion, which is configured to control said virtual disc and said recording/reproducing portion.

2. The optical disc apparatus, as described in the claim 1, wherein said virtual disc is removable from said optical disc apparatus.

3. The optical disc apparatus, as described in the claim 1, wherein said virtual disc is constructed with a semiconductor memory.

4. The optical disc apparatus, as described in the claim 1, wherein said system controller portion takes data, which is recorded on said optical disc, into said virtual disc, with controlling said virtual disc and said recording/reproducing portion, and supplies the data, which is recorded on said optical disc, to a host apparatus, by reading out data from said virtual disc.

5. The optical disc apparatus, as described in the claim 1, wherein said system controller portion takes data, which is transferred from a host apparatus to be recorded on said optical disc, into said virtual disc, with controlling said virtual disc and said recording/reproducing portion, and records on said optical disc the data, which is read out from said virtual disc.
